(19) United States
(12) Patent Application Publication
(10) Pub. No.: US 2009/0226193 A1
(43) Pub. Date: Sep. 10, 2009

(54) IMAGE FORMING APPARATUS, SHEET STATE DETERMINING METHOD, AND SHEET STATE DETERMINING PROGRAM

(75) Inventors: Masataka MURATANI, Akishima-shi (JP); Kazumasa Yasui, Arakawa-ku (JP); Masaya Arakawa, Hiratuka-shi (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/397,008

(22) Filed: Mar. 3, 2009

Related U.S. Application Data
(60) Provisional application No. 61/034,397, filed on Mar. 6, 2008.

(51) Int. Cl. G03G 15/00

(52) U.S. Cl. 399/21

(57) ABSTRACT

To provide, in an image forming apparatus in which a part of a sheet conveying path for reversing a sheet is formed as a unit to be extractable to the outside of the apparatus, a technique for preventing damage to the sheet involved in extracting operation for the extractable unit. In an image forming apparatus that reverses a sheet conveyed in a first conveying direction for leading the sheet to a predetermined discharge tray side by switching back the sheet in a second conveying direction for leading the sheet into a reversing and conveying path, if a sheet is simultaneously detected by both a first sensor that detects a sheet present in an intermediate conveying unit and a second sensor that detects a sheet present in another sheet conveying unit adjacent to an upstream side in the second conveying direction of the intermediate conveying unit, it is determined that the sheet is present across a boundary between the intermediate conveying unit and the other sheet conveying unit.

### CROSS-REFERENCE TO RELATED APPLICATION

This application is based upon and claims the benefit of priority from U.S. provisional application 61/034,397 filed on Mar. 6, 2008, the entire contents of which are incorporated herein by reference.

### TECHNICAL FIELD

The present invention relates to determination of a sheet conveying state in an image forming apparatus, and, more particularly to a technique for determining a sheet conveying state in a conveying path through which a sheet is passed to be reversed.

### BACKGROUND

In the past, there is known an image forming apparatus that reverses print target surfaces of a sheet, which is conveyed in a direction toward a predetermined discharge tray, by switching back the sheet using different sheet conveying paths.

As the image forming apparatus in the past, there is an image forming apparatus in which, in order to allow a user to remove a sheet from a sheet conveying path when sheet clogging (so-called sheet jam) occurs in the sheet conveying path, a part of the sheet conveying path is formed as a unit to be extractable to the outside of the apparatus.

In the image forming apparatus in the past in which a part of the sheet conveying path is formed as the unit extractable to the outside of the apparatus as explained above, when sheet conveyance is stopped by some cause such as a sheet jam, a sheet could be present in both the extractable unit and a sheet conveying path adjacent to the unit and continuous to the sheet conveying path in the unit.

In such a state, if the user attempts to extract the unit to the outside of the apparatus in order to remove the jammed sheet, force in a direction of keeping the sheet in the apparatus acts on the sheet. Therefore, it is likely that the sheet is damaged.

### SUMMARY

It is an object of an embodiment of the present invention to provide, in an image forming apparatus in which a part of a sheet conveying path for reversing a sheet is formed as a unit to be extractable to the outside of the apparatus, a technique for preventing damage to the sheet involved in extracting operation for the extractable unit.

In order to solve the problem, according to an aspect of the present invention, there is provided an image forming apparatus that reverses a sheet conveyed in a first conveying direction for leading the sheet to a predetermined discharge tray side by switching back the sheet in a second conveying direction for leading the sheet into a reversing and conveying path, the apparatus including: an intermediate conveying unit that is located further on an upstream side than the reversing and conveying path in the second conveying direction and in the middle of a sheet conveying path through which the sheet passes during switchback conveyance and is extracted to the outside of the apparatus together with a part of the sheet conveying path; a conveyance guide that forms at least a part of a sheet conveying path in another sheet conveying unit adjacent to the upstream side in the second conveying direction of the intermediate conveying unit and is openable; a first sensor that detects a sheet present in the sheet conveying path in the intermediate conveying unit; a second sensor that detects a sheet present in the sheet conveying path in the other sheet conveying unit; and a determining unit that determines, if a sheet is simultaneously detected by both the first and second sensors, that the sheet is present across a boundary between the intermediate conveying unit and the other sheet conveying unit.

According to another aspect of the present invention, there is provided a sheet state determining method in an image forming apparatus that reverses a sheet conveyed in a first conveying direction for leading the sheet to a predetermined discharge tray side by switching back the sheet in a second conveying direction for leading the sheet into a reversing and conveying path, the apparatus including: an intermediate conveying unit that is located further on an upstream side than the reversing and conveying path in the second conveying direction and in the middle of a sheet conveying path through which the sheet passes during switchback conveyance and is extracted to the outside of the apparatus together with a part of the sheet conveying path; a conveyance guide that forms at least a part of a sheet conveying path in another sheet conveying unit adjacent to the upstream side in the second conveying direction of the intermediate conveying unit and is openable; a first sensor that detects a sheet present in the sheet conveying path in the intermediate conveying unit; and a second sensor that detects a sheet present in the sheet conveying path in the other sheet conveying unit, the method including determining, if a sheet is simultaneously detected by both the first and second sensors, that the sheet is present across a boundary between the intermediate conveying unit and the other sheet conveying unit.

According to still another aspect of the present invention, there is provided a sheet state determining program in an image forming apparatus that reverses a sheet conveyed in a first conveying direction for leading the sheet to a predetermined discharge tray side by switching back the sheet in a second conveying direction for leading the sheet into a reversing and conveying path, the apparatus including: an intermediate conveying unit that is located further on an upstream side than the reversing and conveying path in the second conveying direction and in the middle of a sheet conveying path through which the sheet passes during switchback conveyance and is extracted to the outside of the apparatus together with a part of the sheet conveying path; a conveyance guide that forms at least a part of a sheet conveying path in another sheet conveying unit adjacent to the upstream side in the second conveying direction of the intermediate conveying unit and is openable; a first sensor that detects a sheet present in the sheet conveying path in the intermediate conveying unit; and a second sensor that detects a sheet present in the sheet conveying path in the other sheet conveying unit, the program causing a computer to execute processing for determining, if a sheet is simultaneously detected by both the first and second sensors, that the sheet is present across a boundary between the intermediate conveying unit and the other sheet conveying unit.

### DESCRIPTION OF THE DRAWINGS

FIG. 1 is a schematic diagram for explaining an overall configuration of an image processing system including an image forming apparatus 1 according to an embodiment of the present invention;

FIG. 2 is a longitudinal sectional view for explaining an overall configuration of the image forming apparatus 1 according to the embodiment;

FIG. 3 is an enlarged longitudinal sectional view of a section near a relay reversing unit 2 and a reversing and conveying path 3 for reversal processing for a sheet in the image forming apparatus 1 according to the embodiment;

FIG. 4 is a diagram for explaining a first conveying direction;

FIG. 5 is a diagram for explaining a second conveying direction;

FIG. 6 is a diagram of a state in which entering length into a reversing and retracting path 9A of a sheet is equal to or larger than predetermined length;

FIG. 7 is a diagram of a state in which entering length into the reversing and retracting path 9A of the sheet is smaller than the predetermined length;

FIG. 8 is a diagram of a state in which a lower conveyance guide 9C is opened;

FIG. 9 is a functional block diagram of the image forming apparatus according to the embodiment; and

FIG. 10 is a flowchart of a flow of jam processing in the image forming apparatus according to the embodiment.

### DETAILED DESCRIPTION

An embodiment of the present invention is explained below with reference to the accompanying drawings.

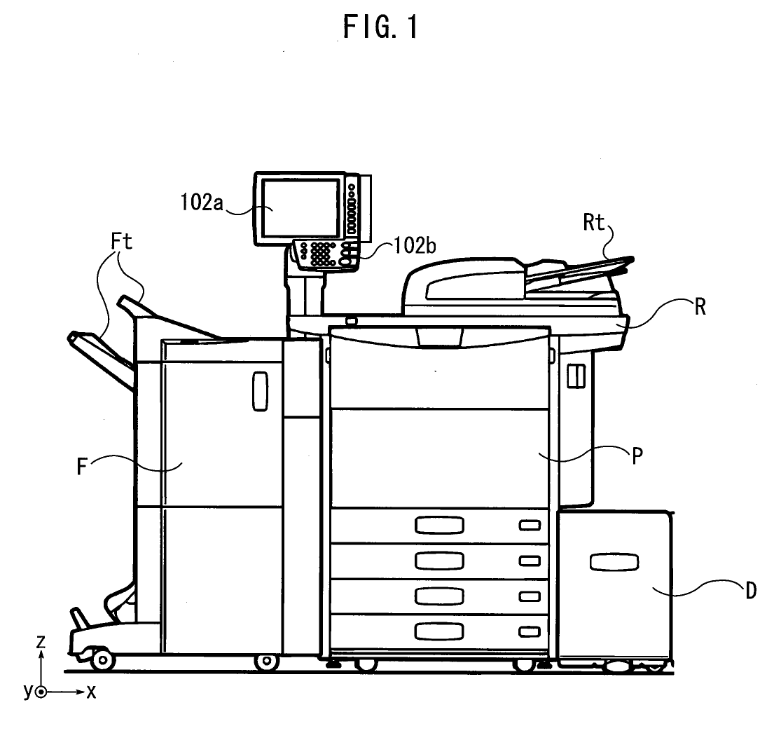

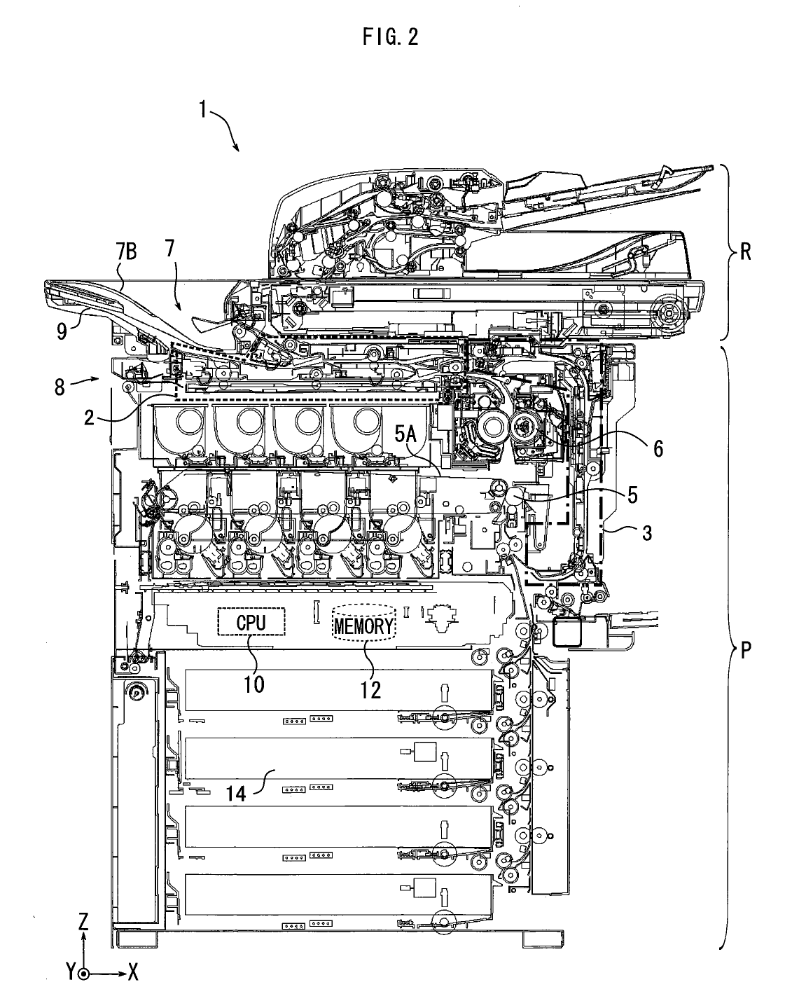

FIG. 1 is a schematic diagram for explaining an overall configuration of an image processing system (MFP: Multi Function Peripheral) including an image forming apparatus 1 according to the embodiment. FIG. 2 is a longitudinal sectional view for explaining an overall configuration of the image forming apparatus 1 according to the embodiment.

First, a schematic configuration of the image processing system including the image forming apparatus 1 according to this embodiment is explained.

As shown in FIG. 1, the image processing system according to this embodiment includes an image scanning unit R, an image forming unit P, a large-capacity paper feeding apparatus D, a post-processing apparatus F, a display unit 102a, and an operation input unit 102b.

The large-capacity paper feeding apparatus D can feed a large number of (e.g., several thousand) sheets as recording media to the image forming unit P.

The post-processing apparatus F is mounted on a side of the image forming apparatus 1 below a paper discharge tray 7B (see FIG. 2) and applies predetermined post-processing to sheets subjected to image formation processing by the image forming unit P. Specifically, the post-processing apparatus F applies so-called “post processing (finishing)” such as stapling, folding, punching, and bookbinding to the sheets subjected to predetermined image formation processing by the image forming unit P and discharges the sheets subjected to the post processing onto a discharge tray Ft.

The display unit 102a can be, for example, an LCD (Liquid Crystal Display), an EL (Electronic Luminescence), a PDP (Plasma Display Panel), or a CRT (Cathode Ray Tube).

The operation input unit 102b can be, for example, a keyboard, a mouse, a touch panel, a touchpad, or a graphics tablet.

Functions of the display unit 102a and the operation input unit 102b can be realized by a so-called touch panel display.

A configuration of the image forming apparatus 1 according to this embodiment is explained.

The image forming apparatus 1 shown in FIG. 2 includes the image forming unit P and the image scanning unit R. The image forming unit P performs processing for forming images on sheets as recording media such as paper and an OHP sheet. The image scanning unit R performs processing for scanning an image on an original document when copy or scan processing is performed.

The image forming unit P includes a relay reversing unit 2 (an intermediate conveying unit) indicated by being surrounded by a dotted line in FIG. 2, a reversing and conveying path 3 indicated by being surrounded by an alternate long and short dash line, a transfer roller 5 and an intermediate transfer belt 5A, a fixing device 6, a paper discharge tray 7B, a first paper discharge port 7, a second paper discharge port 8, a reversing and retracting unit 9 (another sheet conveying unit), a CPU 10, a memory 12, and a sheet feeding unit 14.

The CPU 10 has a role of performing various kinds of processing in the image forming apparatus 1 and also has a role of realizing various functions by executing a computer program stored in the memory 12. The memory 12 can be, for example, a RAM (Random Access Memory), a ROM (Read Only Memory), a DRAM (Dynamic Random Access Memory), an SRAM (Static Random Access Memory), or a VRAM (Video RAM). The memory 12 has a role of storing various kinds of information and computer programs used in the image forming apparatus 1.

A flow of image formation processing in the image forming apparatus 1 according to this embodiment is explained.

When an image is formed only on one side of a sheet by the image forming unit P, first, a sheet is fed from the sheet feeding unit 14 and a developer image formed on the intermediate transfer belt 5A is transferred onto the sheet by the transfer roller 5 (so-called secondary transfer). The developer image on the sheet is heated and fixed thereon by the fixing device 6. The sheet having the image formed thereon is conveyed, through the relay reversing unit 2, to the first paper discharge port 7 for discharging the sheet onto the paper discharge tray 7B or to the second paper discharge port 8 for conveying the sheet to the post-processing apparatus F and discharged to the outside of the image forming apparatus 1. The paper discharge tray 7B is provided to project to an outer side substantially in the horizontal direction (in FIG. 2, to the left side) in the image forming apparatus 1.

On the other hand, when images are formed on both sides of a sheet, after an image is formed on a first side, reversal processing for reversing a side of the sheet opposed to the intermediate transfer belt 5A is performed, then, the sheet is conveyed to a secondary transfer position again, and an image is formed on a second side.

The reversal processing is performed by switching back the sheet on which the developer image heated and fixed by the fixing device 6 to change a conveying direction using a conveying path for reversal and retraction of the relay reversing unit 2 explained later and the reversing and retracting unit 9 and conveying the sheet to the reversing and conveying path 3 such that an end as the trailing end of the sheet during the image formation on the first side is changed to the leading end.

When the reversal processing is performed, if the CPU 10 of the image forming apparatus 1 determines, on the basis of a detection result of a sensor provided in the reversing and conveying path 3 explained later, that the sheet cannot be conveyed to the reversing and conveying path 3 because another sheet is already present in the reversing and conveying path 3, the CPU 10 performs processing for putting the sheet on standby in a predetermined standby position until it becomes possible to convey the sheet. When it becomes possible to convey the sheet to the reversing and conveying path 3, the sheet is conveyed to the reversing and conveying path 3 and reversed. An image is formed on the second side by the intermediate transfer belt 5A and the fixing device 6.

Components related to the reversal processing for a sheet in the image forming apparatus 1 according to this embodiment are explained in detail below.

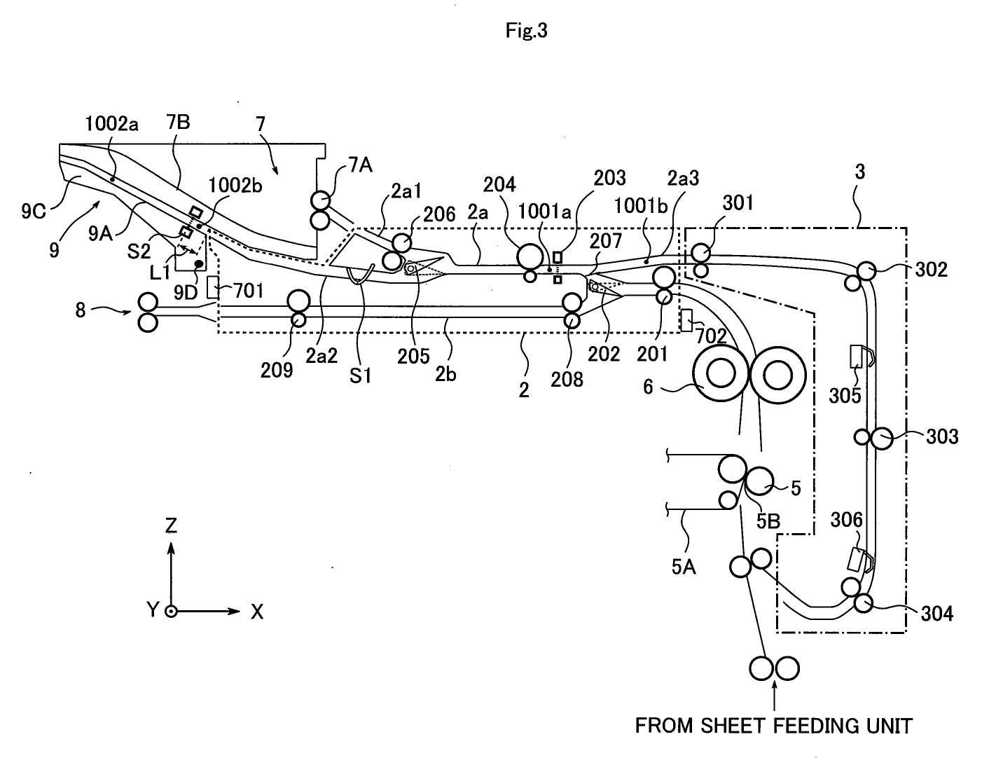

FIG. 3 is an enlarged longitudinal sectional view of a section near the relay reversing unit 2 and the reversing and conveying path 3 for the reversal processing for a sheet in the image forming apparatus 1 according to this embodiment.

The relay reversing unit 2 is a section surrounded by a dotted line in FIG. 3. The reversing and conveying path 3 is a section surrounded by an alternate long and short dash line in FIG. 3.

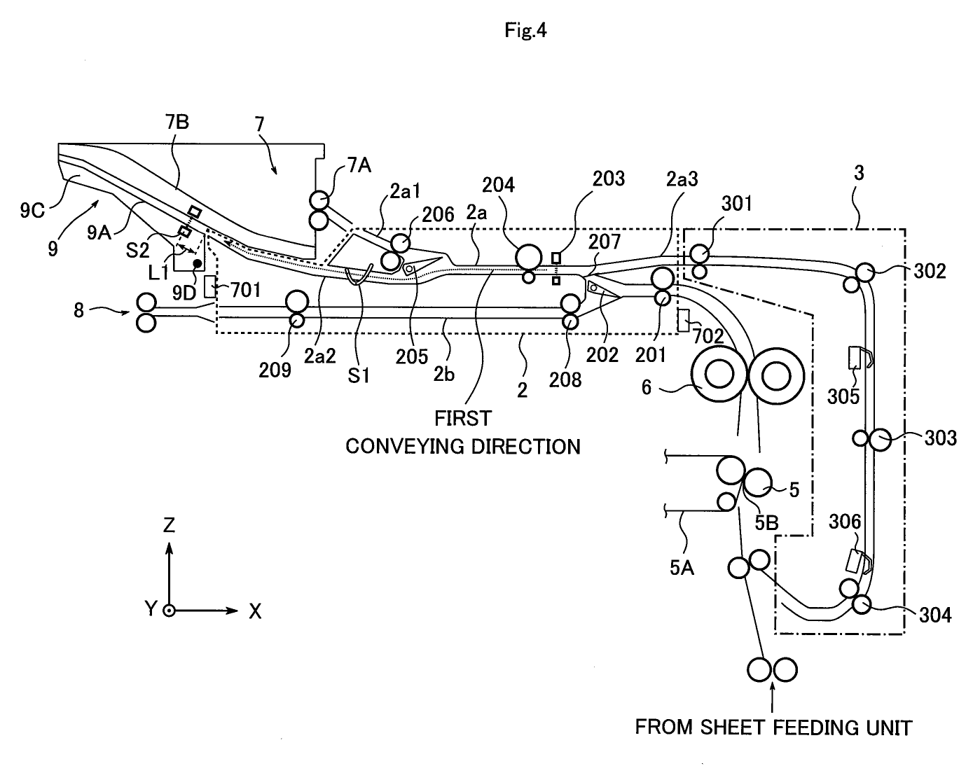

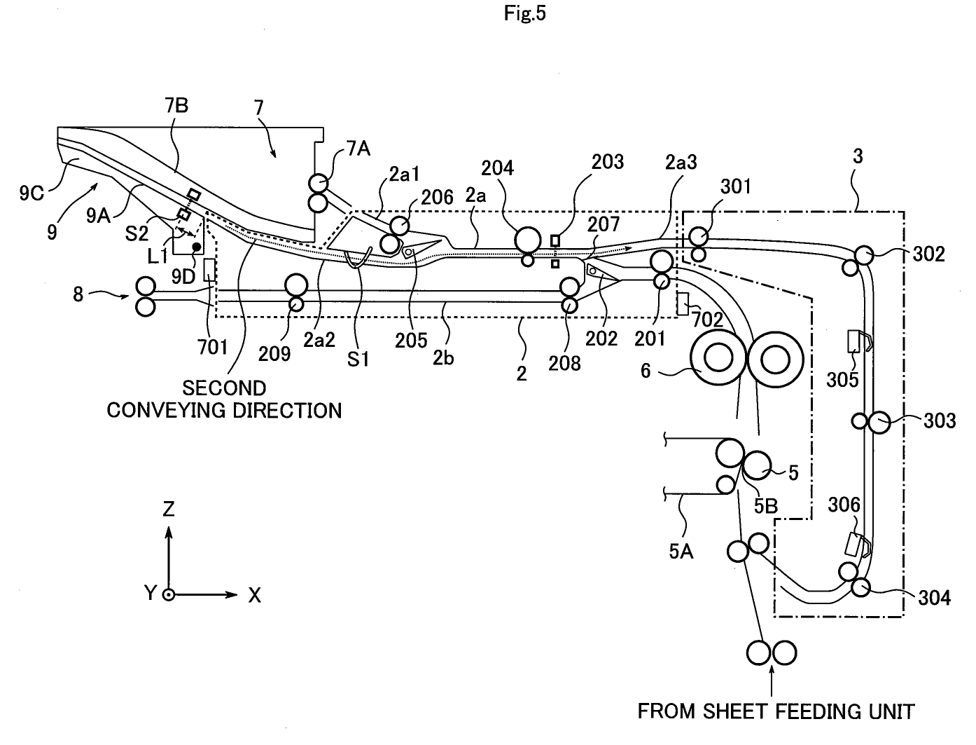

The relay reversing unit 2 conveys a sheet having an image formed thereon to the first paper discharge port 7 or the second paper discharge port 8. In order to perform duplex printing, after once conveying the sheet to the reversing and retracting unit 9 (a first conveying direction shown in FIG. 4), the relay reversing unit 2 switches back the sheet to change a conveying direction of the sheet from the first conveying direction to a second conveying direction (a direction toward the reversing and conveying path 3 shown in FIG. 5) and conveys the sheet to the reversing and conveying path 3.

The relay reversing unit 2 is located between the reversing and conveying path 3 and the reversing and retracting unit 9 (further on the upstream side than the reversing and conveying path 3 in the second conveying direction and in the middle of a sheet conveying path through which the sheet passes during the switchback conveyance). The relay reversing unit 2 is extractable in a Y axis direction (see, for example, FIG. 3) from the image forming apparatus 1 together with a part of the sheet conveying path by slide rails 701 and 702. Consequently, for example, when a sheet jam occurs, it is possible to extract the relay reversing unit 2 and remove a sheet held up in the relay reversing unit 2.

The relay reversing unit 2 includes a first conveying path 2a and a second conveying path 2b. The first conveying path 2a includes a paper discharge conveying path 2a1 that leads a sheet to the first paper discharge port 7 and a retracting path 2a2 through which the sheet is conveyed when the sheet is switched back. A first sensor S1 (an actuator-type sensor) that can detect a sheet present in the retracting path 2a2 is arranged in the retracting path 2a2.

When the sheet is discharged from the first paper discharge port 7, the sheet is conveyed to the paper discharge conveying path 2a1. When the sheet is conveyed to the reversing and conveying path 3 in order to reverse the sheet, the sheet is conveyed to the retracting path 2a2. When the sheet is conveyed to the reversing and conveying path 3 after the switchback of the sheet, the sheet is conveyed to the reversing and conveying path 3 through the reversing path 2a3.

The second conveying path 2b is a conveying path for conveying the sheet to the second paper discharge port 8 when the sheet is discharged from the second paper discharge port 8 and conveyed to, for example, the post processing apparatus F.

Roller pairs 201, 204, 206, 208, and 209 for conveying the sheets in the conveying paths are provided in the respective conveying paths. The relay reversing unit 2 includes a first flapper 202 that selectively switches conveyance of the sheet to the first conveying path 2a or the second conveying path 2b and a second flapper 205 that selectively switches conveyance of the sheet to the paper discharge conveying path 2a1 or the retracting path 2a2.

An optical reversal sensor 203 that detects, for switchback, an end of the sheet is provided on the reversing and conveying path 3 side of the roller pair 204 in a sheet conveying direction in the first conveying path 2a. The reversal sensor 203 is arranged further on a downstream side than a reversal Mylar 207, which is arranged above the first flapper 202, in the first conveying direction of the first conveying path 2a. The reversal Mylar 207 has a function of passing the leading end of a sheet conveyed from the fixing device 6 side to the first conveying path 2a but preventing the leading end of the sheet from entering the fixing device 6 from the first conveying path 2a. Therefore, the reversal sensor 203 is arranged further on the downstream side than the reversal Mylar 207 in the first conveying direction as explained above. Consequently, the sheet is switched back further on the downstream side in the first conveying direction than the reversal Mylar 207 and the switched-back sheet is surely conveyed to the reversing path 2a3.

Operations of the conveying rollers and the flappers in the relay reversing unit 2 are controlled by the CPU 10.

A paper discharge roller pair 7A and a paper discharge tray 7B are provided near the first paper discharge port 7. The sheet conveyed through the paper discharge conveying path 2a1 of the relay reversing unit 2 is discharged onto the paper discharge tray 7B by the paper discharge roller pair 7A.

The reversing and retracting unit 9 is provided to temporarily retract, when the sheet is switched back and conveyed, a portion near the end in the downstream side in the first conveying direction of the sheet until the end on the upstream side in the first conveying direction of the sheet passes the reversal sensor 203 and is switched back. In the image forming apparatus 1 according to this embodiment, the reversing and retracting unit 9 is integrally formed with the paper discharge tray 7B of the first paper discharge port 7 under the paper discharge tray 7B.

The reversing and retracting unit 9 includes a reversing and retracting path 9A connected to the retracting path 2a2 of the relay reversing unit 2 and an optical standby position sensor S2 (equivalent to the second sensor) that detects the passage of the end on the upstream side in the second conveying direction of the sheet during the switchback.

The standby position sensor S2 is arranged in a position where, for example, when standby processing is performed until the sheet becomes capable of entering the reversing and conveying path 3 after the switchback of the sheet, it is possible to put the sheet on standby in a predetermined standby position for preventing the end on the upstream side in the second conveying direction of the sheet from entering the reversing and retracting path 9A by length equal to or larger than predetermined length L1.

In this embodiment, as shown in FIG. 3, the standby position sensor S2 is arranged in a position at the predetermined length L1 on the first conveying direction side from the end on the relay reversing unit 2 side of the reversing and retracting path 9A. Therefore, after the switchback, the conveyance of the sheet is stopped when the standby position sensor S2 detects the passage of the end of the sheet. This makes it possible to put the sheet on standby in the position where the end of the sheet does not enter the reversing and retracting path 9A by a length equal to or larger than the predetermined length.

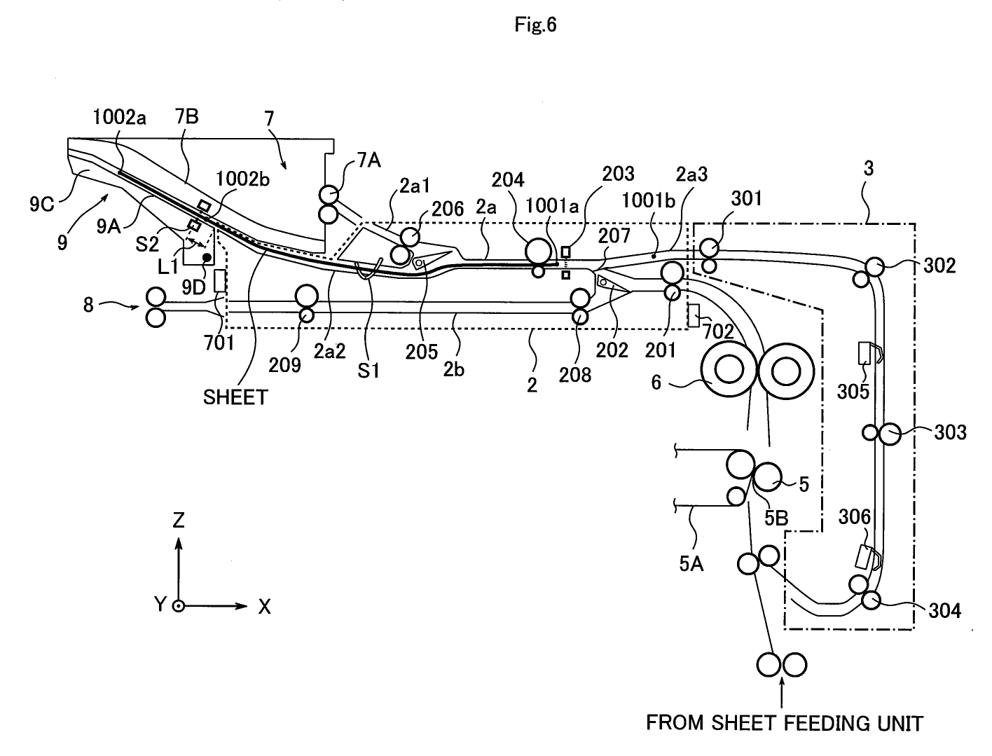

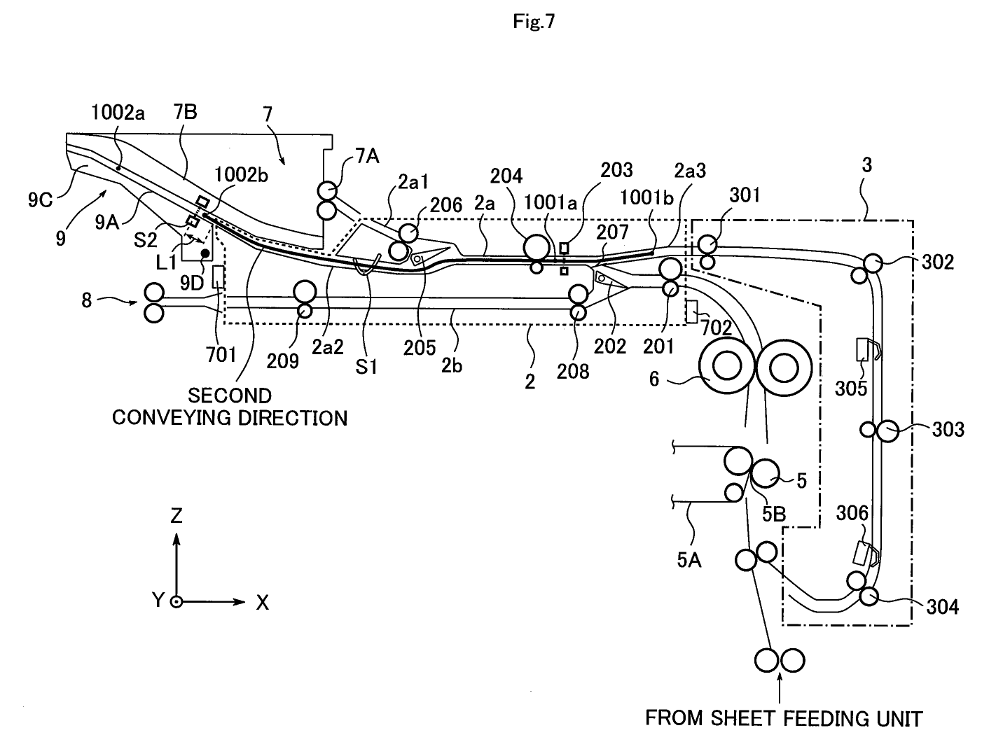

The “predetermined length” means shortest entering length among entering lengths of the sheet into the reversing and retracting path 9A that cause damage in a portion of the sheet entering the reversing and retracting path 9A when the relay reversing unit 2 is extracted from the image forming apparatus 1 in the Y axis direction in FIG. 2. The damage is caused because the end of the sheet enters the reversing and retracting path 9A in a state in which the sheet is put on standby until it becomes possible to convey the sheet to the reversing and conveying path 3. Therefore, for example, if entering length of the sheet into the reversing and retracting path 9A is equal to or larger than the predetermined length in the standby state of the sheet (see FIG. 6), when the relay reversing unit 2 is extracted, a portion of the sheet entering the reversing and retracting path 9A is caught by the reversing and retracting path 9A and damage to the sheet occurs, for example, the sheet is torn or bent. On the other hand, if entering length of the sheet into the reversing and retracting path 9A is smaller than the predetermined length in the standby state of the sheet (see FIG. 7), no damage to the end of the sheet occurs even if the relay reversing unit 2 is extracted. The entering length of the sheet into the reversing and retracting path 9A is smaller than the predetermined length not only when the sheet enters the reversing and retracting path 9A by length smaller than the predetermined length but also when the end of the sheet is present in the relay reversing unit 2 and does not enter the reversing and retracting path 9A at all. In this embodiment, as explained above, for example, as shown in FIG. 3, the “predetermined length” is set to L1.

Specific “predetermined length” changes according to the structure of the image forming apparatus 1. In a general image forming apparatus, usually, the predetermined length is in a range of length larger than 0 mm and equal to or smaller than 20 mm. For example, when the predetermined length L1 of the image forming apparatus 1 according to this embodiment is 15 mm, the sheet is put on standby in a position where entering length of the sheet into the reversing and retracting path 9A is smaller than 15 mm. Consequently, the sheet is not damaged even if the relay reversing unit 2 is extracted.

“Length” in the “predetermined length” means length from a position on the most upstream side in the first conveying direction to a position of the leading end on the downstream side in the first conveying direction in a side end of the sheet that comes into contact with an inner wall of the reversing and retracting path 9A when the relay reversing unit 2 is extracted.

A lower conveyance guide 9C forming a bottom surface of the inner wall of the reversing and retracting path 9A in the reversing and retracting unit 9 (at least a part of the sheet conveying path) is integrally formed with a cover on the lower side of the paper discharge tray 7B. The lower conveyance guide 9C is openable downward around a rotation axis 9D (a predetermined rotation axis).

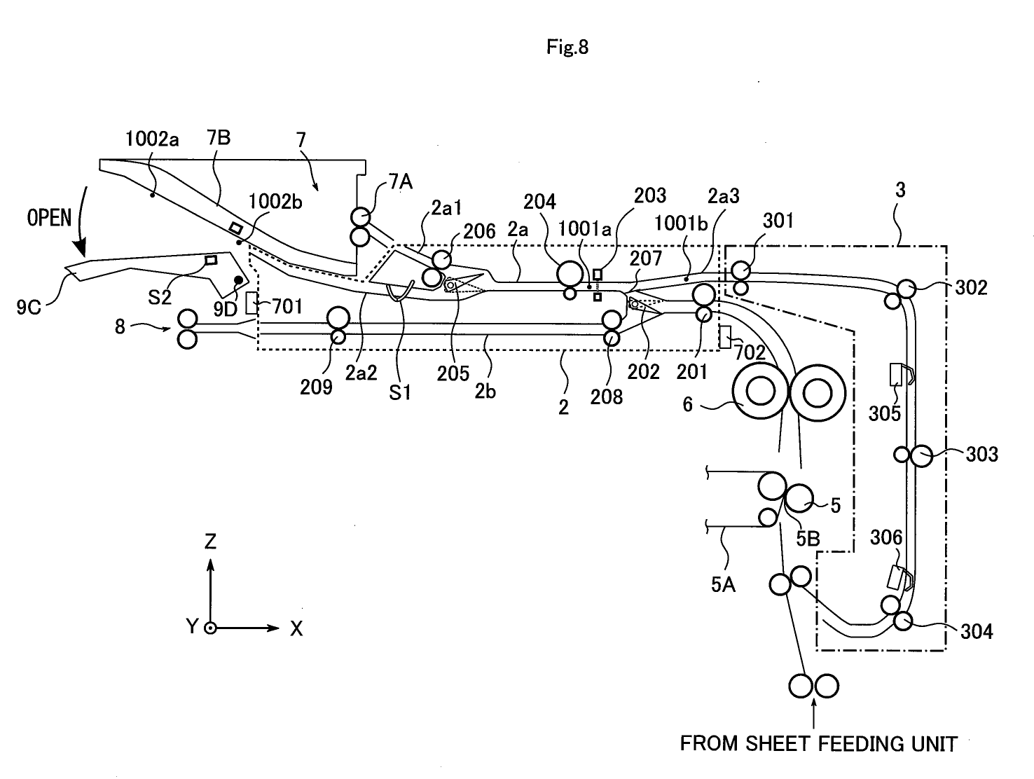

FIG. 8 is a diagram of a state in which the lower conveyance guide 9C is opened. It is preferable that the standby position sensor S2 is arranged further on the upstream side of the reversing and retracting path 9A in the second conveying direction than the rotation axis 9D. Since the position of the standby position sensor S2 is set further on the upstream side in the second conveying direction than the rotation axis 9D in this way, when the lower conveyance guide 9C is opened to eliminate a sheet jam or the like, the standby position sensor S2 portion is integrally opened. Therefore, there is an effect that it is possible to minimize damage to the standby position sensor S2 when the sheet is removed.

The reversing and conveying path 3 is a path for reversing a switch-backed sheet. When the sheet having an image formed on the first side is conveyed through the reversing and conveying path 3 with the end on the downstream side in the second conveying direction set as the leading end, the reversing and conveying path 3 reverses the sheet to make it possible to form an image on the second side of the sheet. When the sheet reversed by being conveyed through the reversing and conveying path 3 is conveyed to the secondary transfer position 5B again, the image is formed on the second side of the sheet.

The reversing and conveying path 3 includes roller pairs 301 to 304, a switch-type sensor 305 that detects entrance of a sheet into the reversing and conveying path 3, and a switch-type sensor 306 that detects conveyance of the sheet near an outlet of the reversing and conveying path 3. The CPU 10 determines, according to presence or absence of a sheet detected by the switch-type sensor 305 and the switch-type sensor 306, whether the sheet can enter the reversing and conveying path 3. If the CPU 10 determines, on the basis of detection results of the sensors 305 and 306, that the sheet cannot enter the reversing and conveying path 3, the CPU 10 puts the sheet on standby in the standby position. On the other hand, if the CPU 10 determines that the sheet can enter the reversing and conveying path 3, the CPU 10 performs processing for conveying the switched-back sheet or the sheet put on standby in the standby position to the reversing and conveying path 3.

As an example of a state in which the sheet cannot enter the reversing and conveying path 3, a sheet is already present in the reversing and conveying path 3 and both the switch-type sensors 305 and 306 detect conveyance of the sheet. As another example, a sheet is present on the upstream side of the reversing and conveying path 3 and only the switch-type sensor 305 detects the sheet.

On the other hand, as an example of a state in which the sheet can enter the reversing and conveying path 3, there is no sheet in the reversing and conveying path 3 and both the switch-type sensors 305 and 306 do not detect conveyance of a sheet. As another example, a sheet being conveyed is already present in the reversing and conveying path 3 but the sheet is short and only the switch-type sensor 306 detects the sheet and, even if the next sheet is conveyed to the reversing and conveying path 3, the next sheet can be stored in the reversing and conveying path 3 without overlapping the sheet already being conveyed.

A flow of an operation of reversal processing involving standby processing for a sheet performed by the image forming apparatus 1 according to this embodiment having the above configuration is explained below.

As explained above, a developer image formed on the intermediate transfer belt 5A is transferred onto a sheet fed from the sheet feeding unit 14 and the developer image is heated and fixed on the sheet by the fixing device 6, whereby an image is formed on the first side of the sheet. The sheet having the image formed on the first side is conveyed from the fixing device 6 in the first conveying direction by the roller pair 201.

When duplex printing is applied to the sheet, the sheet conveyed in the first conveying direction is switched back to be conveyed in the second conveying direction and is conveyed to the reversing and conveying path 3 to be subjected to the reversal processing.

In the reversal processing, first, in order to lead the sheet to the first conveying path 2a and the retracting path 2a2, the CPU 10 controls the first flapper 202 to be lowered and controls the second flapper 205 to be lifted in advance as shown in FIG. 4. In this state, the sheet conveyed from the fixing device 6 is conveyed in the first conveying direction until the end on the upstream side in the first conveying direction of the sheet (i.e., the trailing end in the first conveying direction of the sheet) passes the reversal sensor 203. The end on the downstream side in the first conveying direction of the sheet (i.e., the leading end in the first conveying direction of the sheet) is conveyed to the first conveying path 2a and the retracting path 2a2 (the paper discharge tray side) by the roller pair 204 and the like. The sheet conveyed through the retracting path 2a2 enters the reversing and retracting path 9A in the reversing and retracting unit 9 as another unit adjacent to the relay reversing unit 2.

In a state in which the leading end side of the sheet is retracted by using the first conveying path 2a, the retracting path 2a2, and the reversing and retracting path 9A of the reversing and retracting unit 9 as explained above, when the reversal sensor 203 detects the passage of the trailing end of the sheet, the CPU 10 starts switchback of the sheet.

Specifically, when the reversal sensor 203 detects the passage of the end of the sheet, the CPU 10 performs control to stop the conveyance of the sheet in the first conveying direction by the roller pair 204 and convey the sheet in the second conveying direction. In the example shown in FIG. 6, at a point when the trailing end of the sheet passes the reversal sensor 203 and is switched back in a switchback position 1001a, the leading end of the sheet is retracted into the retracting path 2a2 and the reversing and retracting path 9A and reaches a switchback position 1002a.

After the switchback, another sheet is already held up in the reversing and conveying path 3 and the CPU 10 determines, on the basis of detection results of the sensors 305 and 306 in the reversing and conveying path 3, that the sheet having the image formed on the first side cannot be conveyed to the reversing and conveying path 3. In this case, the image forming apparatus 1 according to this embodiment conveys the sheet in the second conveying direction from the switchback position to the predetermined standby position and puts the sheet on standby in the predetermined standby position.

In the state shown in FIG. 6, at the start of the switchback, the end on the upstream side in the second conveying direction of the sheet (i.e., the trailing end in the second conveying direction of the sheet) is present in the switchback position 1002a. The end on the upstream side enters the reversing and retracting path 9A by length equal to or larger than the predetermined length L1. If the relay reversing unit 2 is extracted in this state, it is likely that the sheet entering the reversing and retracting path 9A is damaged. Therefore, the CPU 10 drives the roller pairs to convey the sheet in the second conveying direction until the entering length of the sheet into the reversing and retracting path 9A is reduced to be smaller than the predetermined length L1 and puts the sheet on standby.

Specifically, after switching back the sheet in the switchback position 1002a, the CPU 10 conveys the sheet in the second conveying direction until it is detected that the end on the upstream side in the second direction of the sheet passes the standby position sensor S2. When the passage of the end on the upstream side of the sheet is detected by the standby position sensor S2, the CPU 10 stops the driving of the roller pair 204 and puts the sheet on standby. In the case of the sheet in the state shown in FIG. 6, the end of the sheet in the reversing and retracting path 9A moves from the switchback position 1002a to the standby position 1002b, the end of the sheet on the reversing and conveying path 3 side moves from the switchback position 1001a to the standby position 1001b, and the sheet is put on standby.

According to the standby processing after the switchback explained above, the image forming apparatus 1 can put the sheet on standby in a state in which the end of the sheet does not enter the reversing and retracting path 9A of the reversing and retracting unit 9 adjacent to the relay reversing unit 2 by length equal to or larger than the predetermined length L1. Therefore, there is an effect that, even if a sheet jam or the like occurs in this standby state and the relay reversing unit 2 is extracted from the image forming apparatus 1, a portion of the sheet on the reversing and retracting unit 9 side is not damaged. Consequently, it is possible to prevent waste of sheets due to damage to the sheets and prevent deficiencies in the image forming apparatus 1 caused by a part of a torn sheet remaining in the image forming apparatus 1.

Determination of jam processing time in the image forming apparatus 1 according to this embodiment is explained below.

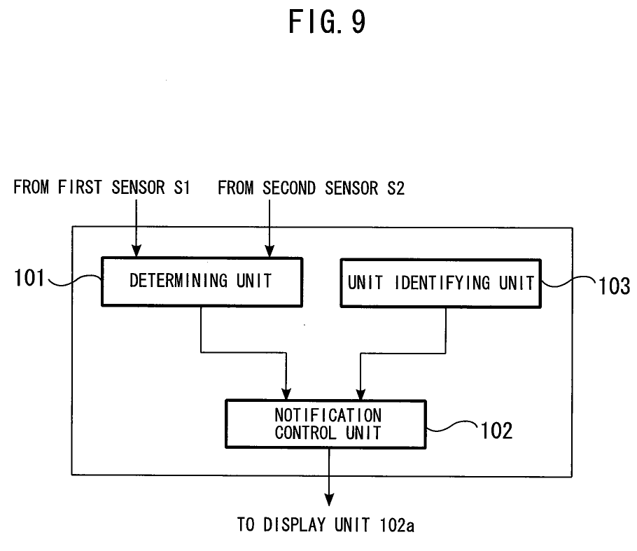

FIG. 9 is a functional block diagram of the image forming apparatus 1 according to this embodiment.

As shown in FIG. 9, the image forming apparatus 1 according to this embodiment includes a determining unit 101, a notification control unit 102, and a unit identifying unit 103.

Functions of the determining unit 101, the notification control unit 102, and the unit identifying unit 103 are realized by causing the CPU 10 to execute a sheet state determining program stored in the memory 12 or a storage area provided in the image forming apparatus 1.

If a sheet is simultaneously detected by both the first sensor S1 and the standby position sensor S2, the determining unit 101 determines that the sheet is present across a boundary between the relay reversing unit 2 and the reversing and retracting unit 9.

If the determining unit 101 determines that the sheet is present across the boundary between the relay reversing unit 2 and the reversing and retracting unit 9, the notification control unit 102 causes the display unit 102a to perform notification for urging the user to open the lower conveyance guide 9C before extracting the relay reversing unit 2.

The unit identifying unit 103 identifies a processing unit to be mounted on the image forming apparatus 1.

If the processing unit identified by the unit identifying unit 103 prevents the opening of the lower conveyance guide 9C, the notification control unit 102 causes the display unit 102a to notify to the effect that, before the lower conveyance guide 9C is opened, the processing unit should be retracted to a position where the processing unit does not prevent the opening of the lower conveyance guide 9C.

A flow of processing performed when a sheet jam occurs in the image forming apparatus 1 according to this embodiment is explained.

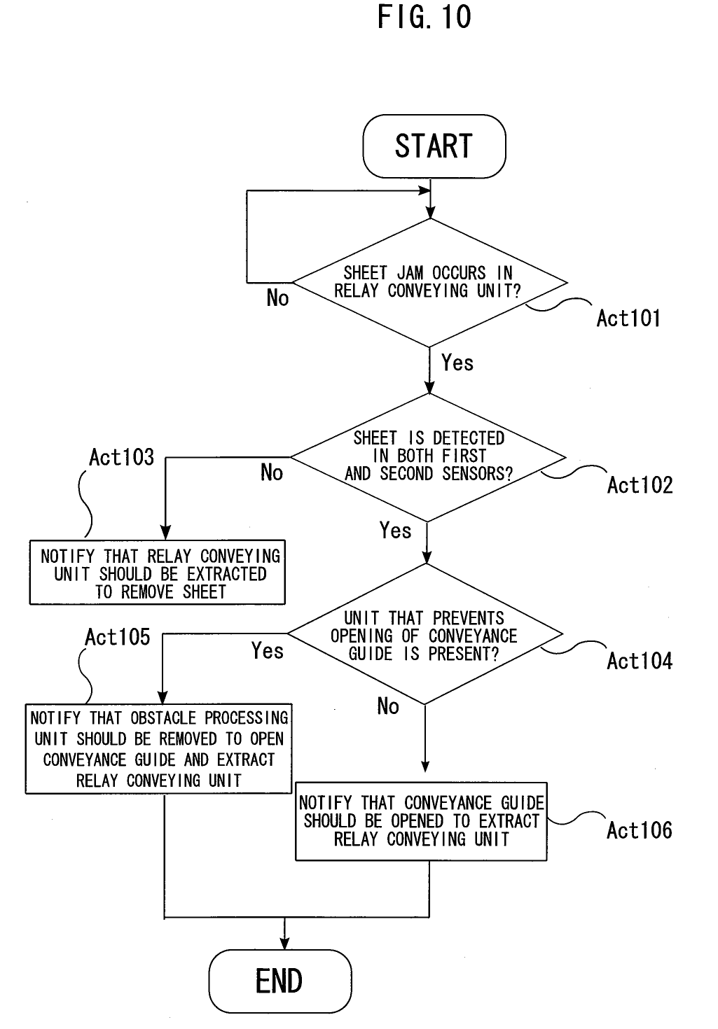

FIG. 10 is a flowchart of a flow of jam processing in the image forming apparatus 1 according to this embodiment.

If the CPU 10 determines, on the basis of, for example, a sheet detection result in any one of the first sensor S1, the standby position sensor S2, and the reversal sensor 203, that a sheet jam occurs in the relay reversal unit 2 (Act 101, Yes), the determining unit 101 determines whether the sheet is simultaneously detected by both the first sensor S1 and the standby position sensor S2 (Act 102).

If the sheet is not simultaneously detected by the first sensor S1 and the standby position sensor S2 (Act 102, No), the determining unit 101 determines that a sheet across the boundary between the relay reversing unit 2 and the reversing and retracting unit 9 is not present. In this case, the notification control unit 102 causes the display unit 102a to notify to the effect that the sheet jam should be eliminated by opening the lower conveyance guide 9C (Act 103).

On the other hand, if a sheet is simultaneously detected by both the first sensor S1 and the standby position sensor S2 (Act 102, Yes), the determining unit 101 determines that the sheet across the boundary between the relay reversing unit 2 and the reversing and retracting unit 9 is present. Subsequently, the unit identifying unit 103 identifies a processing unit mounted on the image forming apparatus 1 (Act 104).

If the processing unit identified by the unit identifying unit 103 prevents the opening of the lower conveyance guide 9C (e.g., when the post-processing unit F is mounted right below the paper discharge tray 7B as a processing unit), the notification control unit 102 causes the display unit 102a to notify to the effect that, before the lower conveyance guide 9C is opened, the processing unit should be retracted to a position where the processing unit does not prevent the opening of the lower conveyance guide 9C (e.g., the processing unit is removed from the image forming apparatus 1) (Act 105).

On the other hand, if the processing unit identified by the unit identifying unit 103 does not prevent the opening of the lower conveyance guide 9C, the notification control unit 102 causes the display unit 102a to notify to the effect that the lower conveyance guide 9C should be opened to attempt sheet removal before the relay reversing unit 2 is extracted (Act 106).

If a sheet is detected only by the first sensor S1 in Act 102, there is no sheet projecting from the sheet conveying path of the relay reversing unit 2 to the reversing and retracting path 9. Therefore, it is unnecessary to open the lower conveyance guide 9C when the sheet jam is eliminated. In other words, work for opening the lower conveyance guide 9C and checking presence or absence of a sheet in the reversing and retracting path 9A is omitted from a work procedure for eliminating the sheet jam.

As explained above, according to this embodiment, it is necessary to operate the lower conveyance guide 9C of the paper discharge tray 7B forming the lower left of the reversing and retracting path 9A only when a sheet is simultaneously detected by the first sensor S1 and the standby position sensor S2. Therefore, it is possible to clearly display, only when necessary, a message for urging operation of the lower conveyance guide 9C to the user to omit the operation for opening the lower conveyance guide 9C from the normal sheet jam eliminating work. This contributes to a substantial reduction in work load when a sheet jam occurs.

In the image forming apparatus 1 according to this embodiment, it is possible to remove a sheet jammed in the apparatus according to any one of procedures (1) to (3) below or a combination of these procedures.
(1) Remove a sheet entering the relay reversing unit 2

Specifically, a jammed sheet is removed from the fixing device side. A sheet jammed near an inlet to the reversing and conveying path 3 after reversal is removed.
(2) Remove a sheet being discharged from the relay reversing unit 2

Specifically, a jammed sheet is removed from the paper discharge tray 7B side.
(2b) When there is a sheet put on standby for reversal and length of the leading end of the sheet extending out to the area of the relay reversing unit 2 is equal to or larger than fixed length, open the lower conveyance guide 9C to remove the sheet from the outside
(3) Extract the relay reversing unit 2 to the outside of the apparatus and remove a sheet jammed in the relay reversing unit 2

With the image forming apparatus 1 according to this embodiment, since the lower conveyance guide 9C is openable, it is possible to perform the operation (2b) after the procedures (1) and (2a).

However, work for checking a state of a sheet jam by opening the lower conveyance guide 9C is not work that always needs to be performed when a sheet jam occurs but is rather operation that is very rarely necessary.

With the image forming apparatus 1 according to this embodiment, since the image forming apparatus 1 notifies the user that that the user should open the lower conveyance guide 9C only when it is necessary to open the lower conveyance guide 9C, it is possible to prevent the user from performing an unnecessary check.

The operations in the processing in the image forming apparatus 1 are realized by causing the CPU 10 to execute the sheet state determining program stored in the memory 12.

A computer program that causes a computer configuring the image forming apparatus to execute the operations can be provided as the sheet state determining program. In the example explained in this embodiment, the computer program for realizing the functions for carrying out the present invention is recorded in advance in the storage area provided in the apparatus. However, present invention is not limited to this. The same computer program may be downloaded from a network to the apparatus or the same computer program stored in a computer-readable recording medium may be installed in the apparatus. A form of the recording medium may be any form as long as the recording medium can store the computer program and can be read by the computer. Specifically, examples of the recording medium include internal storage devices implemented in the computer such as a ROM and a RAM, portable storage media such as a CD-ROM, a flexible disk, a DVD disk, a magneto-optical disk, and an IC card, a database that stores a computer program, other computers and databases for the computers, and a transmission medium on a line. Functions obtained by the installation and the download in this way may realize the functions in cooperation with an OS (operating system) in the apparatus.

The computer program in this embodiment includes a computer program for dynamically generating an execution module.

In the example explained in the embodiment, the first sensor S1 is the actuator-type sensor, the reversal sensor 203 and the standby position sensor S2 are the optical sensors, and the switch-type sensor 305 and the switch-type sensor 306 in the reversing and conveying path 3 are the sensors of the switch type. However, the present invention is not limited to this. Any sensor may be adopted as long as the sensor can detect the passage of a sheet such as a reflective sensor and a transmissive sensor.

The arrangement of the first sensor S1 and the standby position sensor S2 is not always limited to the positions explained in the embodiment. It goes without saying that the first sensor S1 and the standby position sensor S2 may be arranged in other positions as long as the sensors can detect a sheet present in the reversing and retracting path 9 and the relay reversing unit 2.

In the example explained in the embodiment, it is determined on the basis of sheet detection results in the two sensors whether a sheet across the boundary between the relay reversing unit 2 and the reversing and retracting unit 9 is present. However, the present invention is not always limited to this. It goes without saying that, for example, it is also possible to perform the determination using sheet detection results of two or more sensors arranged in each of the relay reversing unit 2 and the reversing and retracting unit 9.

In the example of the procedure explained with reference to the flowchart shown in FIG. 10, after determining whether the sheet is simultaneously detected by both the first and second sensors (Act 102), the determining unit 101 determines whether a processing unit that prevents the opening of the lower conveyance guide 9C is mounted on the main body of the image forming apparatus (Act 104). However, a processing procedure in the sheet state determining method is not always limited to this procedure by the present invention. For example, the processing in Act 104 may be performed prior to the processing in Act 102. The processing in ACT 102 and the processing in Act 104 can be simultaneously performed. In other words, results obtained by the determination processing in Act 102 and Act 104 only have to be acquired at timing when the determination processing for determining contents of notification by the notification control unit 102 is executed.

In the example explained in the embodiment, the notification processing by the notification control unit 102 is realized by screen display on the display unit 102a. However, the present invention is not limited to this. For example, the notification can be realized by processing such as sound notification by a speaker incorporated in the image forming apparatus 1 or flashing of a lamp provided in the image forming apparatus 1.

The present invention is explained in detail above with reference to the specific embodiment. However, it would be apparent to those skilled in the art that various modifications and alterations can be made without departing from the spirit and the scope of the present invention.

As explained above in detail, it is possible to provide, in an image forming apparatus in which a part of a sheet conveying path for reversing a sheet is formed as a unit to be extractable to the outside of the apparatus, a technique for preventing damage to the sheet involved in extracting operation for the extractable unit.

What is claimed is:

1. An image forming apparatus that reverses a sheet conveyed in a first conveying direction for leading the sheet to a predetermined discharge tray side by switching back the sheet in a second conveying direction for leading the sheet into a reversing and conveying path, the apparatus comprising:
an intermediate conveying unit that is located further on an upstream side than the reversing and conveying path in the second conveying direction and in the middle of a sheet conveying path through which the sheet passes during switchback conveyance and is extracted to an outside of the apparatus together with a part of the sheet conveying path;
a conveyance guide that forms at least a part of a sheet conveying path in another sheet conveying unit adjacent to the upstream side in the second conveying direction of the intermediate conveying unit and is openable;
a first sensor that detects a sheet present in the sheet conveying path in the intermediate conveying unit;
a second sensor that detects a sheet present in the sheet conveying path in the other sheet conveying unit; and
a determining unit that determines, if a sheet is simultaneously detected by both the first and second sensors, that the sheet is present across a boundary between the intermediate conveying unit and the other sheet conveying unit.

2. The apparatus according to claim 1, wherein the conveyance guide is integrally formed with an upper or lower cover of the discharge tray.

3. The apparatus according to claim 2, wherein
the discharge tray is provided to project to an outer side in a horizontal direction in the apparatus, and
the conveyance guide is integrally formed with the lower cover of the discharge tray that opens downward.

4. The apparatus according to claim 1, wherein
the conveyance guide is openable around a predetermined rotation axis, and
the second sensor is located further on the upstream side than the predetermined rotation axis in the second conveying direction.

5. The apparatus according to claim 1, further comprising a notification control unit that causes, if the determining unit determines that the sheet is present across the boundary between the intermediate conveying unit and the other sheet conveying unit, a display unit to perform notification for urging a user to open the conveyance guide before extracting the intermediate conveying unit.

6. The apparatus according to claim 5, wherein
the conveyance guide is integrally formed with a lower cover that opens downward to below the discharge tray provided to project to an outer side in a horizontal direction in the apparatus,
a processing unit that performs predetermined processing is detachably attachable to a side of the apparatus below the discharge tray,
the apparatus further includes a unit identifying unit that identifies the processing unit mounted on the apparatus, and
the notification control unit causes, when the processing unit identified by the unit identifying unit prevents the opening of the conveyance guide, the display unit to notify to the effect that, before the conveyance guide is opened, the processing unit should be retracted to a position where the processing unit does not prevent the opening of the conveyance guide.

7. A sheet state determining method in an image forming apparatus that reverses a sheet conveyed in a first conveying direction for leading the sheet to a predetermined discharge tray side by switching back the sheet in a second conveying direction for leading the sheet into a reversing and conveying path, the apparatus including: an intermediate conveying unit that is located further on an upstream side than the reversing and conveying path in the second conveying direction and in the middle of a sheet conveying path through which the sheet passes during switchback conveyance and is extracted to an outside of the apparatus together with a part of the sheet conveying path; a conveyance guide that forms at least a part of a sheet conveying path in another sheet conveying unit adjacent to the upstream side in the second conveying direction of the intermediate conveying unit and is openable; a first sensor that detects a sheet present in the sheet conveying path in the intermediate conveying unit; and a second sensor that detects a sheet present in the sheet conveying path in the other sheet conveying unit,
the method comprising determining, if a sheet is simultaneously detected by both the first and second sensors, that the sheet is present across a boundary between the intermediate conveying unit and the other sheet conveying unit.

8. The method according to claim 7, wherein the conveyance guide is integrally formed with an upper or lower cover of the discharge tray.

9. The method according to claim 8, wherein
the discharge tray is provided to project to an outer side in a horizontal direction in the apparatus, and
the conveyance guide is integrally formed with the lower cover of the discharge tray that opens downward.

10. The method according to claim 7, wherein
the conveyance guide is openable around a predetermined rotation axis, and
the second sensor is located further on the upstream side than the predetermined rotation axis in the second conveying direction.

11. The method according to claim 7, further comprising causing, if it is determined that the sheet is present across the boundary between the intermediate conveying unit and the other sheet conveying unit, a display unit to perform notification for urging a user to open the conveyance guide before extracting the intermediate conveying unit.

12. The method according to claim 11, wherein
the conveyance guide is integrally formed with a lower cover that opens downward to below the discharge tray provided to project to an outer side in a horizontal direction in the apparatus,
a processing unit that performs predetermined processing is detachably attachable to a side of the apparatus below the discharge tray, and
the method further including:
identifying the processing unit mounted on the apparatus; and
causing, when the processing unit identified by the unit identifying unit prevents the opening of the conveyance guide, the display unit to notify to the effect that, before the conveyance guide is opened, the processing unit should be retracted to a position where the processing unit does not prevent the opening of the conveyance guide.

13. A sheet state determining program in an image forming apparatus that reverses a sheet conveyed in a first conveying direction for leading the sheet to a predetermined discharge tray side by switching back the sheet in a second conveying direction for leading the sheet into a reversing and conveying path, the apparatus including: an intermediate conveying unit that is located further on an upstream side than the reversing and conveying path in the second conveying direction and in the middle of a sheet conveying path through which the sheet passes during switchback conveyance and is extracted to the outside of the apparatus together with a part of the sheet conveying path; a conveyance guide that forms at least a part of a sheet conveying path in another sheet conveying unit adjacent to the upstream side in the second conveying direction of the intermediate conveying unit and is openable; a first sensor that detects a sheet present in the sheet conveying path in the intermediate conveying unit; and a second sensor that detects a sheet present in the sheet conveying path in the other sheet conveying unit,
the program causing a computer to execute processing for determining, if a sheet is simultaneously detected by both the first and second sensors, that the sheet is present across a boundary between the intermediate conveying unit and the other sheet conveying unit.

14. The program according to claim 13, wherein the conveyance guide is integrally formed with an upper or lower cover of the discharge tray.

15. The program according to claim 14, wherein
the discharge tray is provided to project to an outer side in a horizontal direction in the apparatus, and
the conveyance guide is integrally formed with the lower cover of the discharge tray that opens downward.

16. The program according to claim 13, wherein
the conveyance guide is openable around a predetermined rotation axis, and
the second sensor is located further on the upstream side than the predetermined rotation axis in the second conveying direction.

17. The program according to claim 13, further causing the computer to execute processing for causing, if the determining unit determines that the sheet is present across the boundary between the intermediate conveying unit and the other sheet conveying unit, a display unit to perform notification for urging a user to open the conveyance guide before extracting the intermediate conveying unit.

18. The program according to claim 17, wherein
the conveyance guide is integrally formed with a lower cover that opens downward to below the discharge tray provided to project to an outer side in a horizontal direction in the apparatus,
a processing unit that performs predetermined processing is detachably attachable to a side of the apparatus below the discharge tray, and
the program further causing the computer to execute processing for:
identifying the processing unit mounted on the apparatus, and
causing, when the processing unit identified by the unit identifying unit prevents the opening of the conveyance guide, the display unit to notify to the effect that, before the conveyance guide is opened, the processing unit should be retracted to a position where the processing unit does not prevent the opening of the conveyance guide.
